(19) United States
(12) Patent Application Publication
(10) Pub. No.: US 2023/0234073 A1
(43) Pub. Date: Jul. 27, 2023

(54) Magnetic Filter

(71) Applicant: LG Energy Solution, Ltd., Seoul (KR)

(72) Inventors: Guktae Kim, Daejeon (KR); Sang Jin Hong, Daejeon (KR); Yu Sang Jeong, Daejeon (KR)

(73) Assignee: LG Energy Solution, Ltd., Seoul (KR)

(21) Appl. No.: 18/096,294

(22) Filed: Jan. 12, 2023

(30) Foreign Application Priority Data
Jan. 25, 2022 (KR) 10-2022-0010580

(51) Int. Cl. B03C 1/03

(52) U.S. Cl. CPC B03C 1/03; B03C 2201/22; B03C 2201/20

(57) ABSTRACT

A magnetic filter according to one embodiment of the present disclosure includes a housing through which fluid or powder containing metal particles passes; magnets arranged inside the housing; and a rotation unit that rotates the magnets so as to revolve around the rotation center, wherein the magnets include first magnets and second magnets located farther from the rotation center than the first magnets, and wherein any one of the second magnets forms an equilateral triangle arrangement with two first magnets adjacent to any one of the second magnets.

### CROSS-REFERENCE TO RELATED APPLICATIONS

The present application claims priority to Korean Patent Application No. 10-2022-0010580, filed on Jan. 25, 2022, the disclosure of which is hereby incorporated by reference herein in its entirety.

### TECHNICAL FIELD

The present disclosure relates to a magnetic filter, and more particularly, to a rotary type magnetic filter.

### BACKGROUND

Metallic foreign matters cause many problems in various processes. Such metallic foreign matters be included in the raw materials themselves or may occur in process-related facilities, and can generally be removed by magnetic filters. In addition, the magnetic filters may be classified into those utilizing magnetic force induced by electricity and those utilizing permanent magnets.

The magnetic filters are used to collect and separate metallic foreign matters, that is, metal particles, that interfere with the smooth progress of the process using a magnetic force, and are mainly used to separate metal particles that are contained in fluids or powders supplied through pipes or the like.

The collection efficiency of metal particles contained in the fluid or powder passing through the housing is determined in accordance with the magnetic field and flow field applied to the metal particles. The strength of the magnetic field acting on the metal particles varies depending on the distance between the metal particles and the magnets. As the distance between the metal particles and the magnets increases, the strength of the magnetic field that the metal particles receive decreases, and the metal particle collection efficiency of the magnet filter decreases. In addition, depending on the shape of the housing, the flow deviation of the fluid or powder containing metal particles occurs inside the housing, thereby reducing the collection efficiency.

FIG. 1 is a plan view showing a conventional rotary type magnetic filter 10a. Specifically, when viewing the xy plane as a plane parallel to the ground, it shows an appearance of the conventional rotary type magnetic filter 10 as viewed from above.

Referring to FIG. 1, a conventional rotary type magnetic filter 10a may include a housing 30a through which fluid or powder passes and a plurality of magnets 20a provided inside the housing 30a. The magnets 20a may have a columnar shape extending along the height direction of the housing 30a, and may be disposed spaced apart from each other at constant intervals. Here, the height direction is a direction perpendicular to the ground which may be a direction parallel to the z-axis. The housing 30a may include an inlet port 31a and an outlet port 32a that communicate with the inner space in which the magnets 20a are housed. The fluid or powder containing metal particles flows into the housing 30a through the inlet port 31a and is discharged through the outlet port 32a.

The plurality of magnets 20a are arranged so as to have a certain distance from the rotation center 40a, and are fixed to a rotation plate so as to be rotatable around the rotation center 40a. In the conventional rotary type magnetic filter 10a, the fluid or powder containing metal particles flows into the inside of the housing 30a, the metal particles inside the fluid or powder can be collected through the plurality of magnets 20a rotating around the rotation center 40a and then discharged to the outside.

The rotary type magnetic filter 10a was designed with a focus on the flow characteristics of fluids and powders in order to solve a material clogging phenomenon, which is a drawback of the grate type magnetic filter described later. However, there is a region where the magnetic force does not reach because the distance between the magnets 20a is wide, and compared to a grate type magnet filter, a small number of magnets 20a are arranged in the same space, which causes a problem that the foreign matter removal capability is deteriorated.

FIG. 2 is a plan view showing a conventional grate type magnetic filter 10b. Specifically, when viewing the xy plane as a plane parallel to the ground, it shows a state of the conventional grate type magnetic filter 10b as viewed from above.

Referring to FIG. 2, a conventional grate type magnetic filter 10b may include a housing 30b through which fluid or powder passes and a plurality of magnets 20b provided inside the housing 30b. The magnets 20b may have a columnar shape extending along the height direction of the housing 30b, and may be disposed spaced apart from each other at constant intervals. Here, the height direction is a direction perpendicular to the ground which may be a direction parallel to the z-axis. The housing 30b may include an inlet port 31b and an outlet port 32b that communicate with the inner space in which the magnets 20b are housed. The fluid or powder containing metal particles flows into the housing 30b through the inlet port 31b and is discharged through the outlet port 32b.

A plurality of magnets 20b may be arranged in a plurality of rows, and magnets 20b located in any one column may be located so as to be deviated from magnets 20b located in other adjacent row, which may be arranged in a kind of zigzag shape. Fluid or powder containing metal particles flows into the inside of the housing 30b, metal particles inside the fluid or powder can be collected through these magnets 20b and then discharged to the outside.

The grate type magnetic filter 10b has excellent foreign matter removal capability as compared to the conventional rotary type magnetic filter, but there is a problem that flow characteristics of fluid or powder are not good, and a material clogging phenomenon occurs. In particular, with the recent growth of the secondary battery market, ease of mass production has become important, but the grate type magnetic filter 10b, in which input of raw materials may be delayed due to a material clogging phenomenon, may have limitations in application.

Therefore, there is a need to develop a magnetic filter with an improved structure that is excellent in flowability of fluids or powders and foreign matter removal performance.

### BRIEF SUMMARY OF THE INVENTION

### Technical Problem

The present disclosure has been designed to solve the above-mentioned problems and an object of the present disclosure is to provide a magnetic filter that secures flowability of a fluid and, at the time, increases foreign matter removal performance and collection efficiency.

However, the technical problem to be solved by embodiments of the present disclosure is not limited to the above-described problems, and can be variously expanded within the scope of the technical idea included in the present disclosure.

### Technical Solution

According to one embodiment of the present disclosure, there is provided a magnetic filter comprising: a housing through which fluid or powder containing metal particles passes; magnets arranged inside the housing; and a rotation unit that rotates the magnets so as to revolve around the rotation center, wherein the magnets include first magnets and second magnets located farther from the rotation center than the first magnets, and wherein any one of the second magnets forms an equilateral triangle arrangement with two first magnets adjacent to any one of the second magnets.

The first magnets may be arranged in a circular shape with respect to the rotation center.

The first magnets may be arranged in a polygonal shape with respect to the rotation center.

The magnets may have a columnar shape extending along one direction.

The housing may include an inlet port through which the fluid or powder flow in and an outlet port through which the fluid or powder flowed from the inlet port is discharged, and an opening direction of the inlet port and an opening direction of the outlet port may be parallel to each other.

The magnetics may have a columnar shape extending along a direction perpendicular to a direction from the inlet port to the outlet port.

The magnets may further comprise third magnets arranged between the second magnets.

The third magnets may be separated by the same distance as each of the adjacent second magnets.

One of the third magnets may form an equilateral triangle arrangement with one of the second magnets adjacent to one of the third magnets and the first magnets adjacent to one of the third magnets.

The rotation unit may comprise a first rotation plate connected to one end of the first magnets and one end of the second magnets; a second rotation plate connected to the other end of the first magnets and the other end of the second magnets; and a rotary motor connected to any one of the first rotation plate and the second rotation plate.

### Advantageous Effects

According to embodiments of the present disclosure, the rotatable magnets are arranged in a close-packed structure based on the magnetic force effective range where the magnetic force is exerted, thereby capable of securing the flowability of fluid inside the magnet filter, and at the same time, improving the foreign matter removal performance and collection efficiency.

The effects of the present disclosure are not limited to the effects mentioned above and additional other effects not described above will be clearly understood from the description of the appended claims by those skilled in the art.

### BRIEF DESCRIPTION OF THE DRAWINGS

FIG. 1 is a plan view showing a conventional rotary type magnetic filter;

FIG. 2 is a plan view showing a conventional grate type magnetic filter;

FIG. 3 is a side view showing a side surface of a magnetic filter according to an embodiment of the present disclosure;

FIG. 4 is a cross-sectional view taken along the line A-A′ of FIG. 3;

FIG. 5 is a cross-sectional view schematically showing only magnets in the magnetic filter of FIG. 4;

FIG. 6 is a schematic diagram expressing the magnetic force effective range of the magnets according to the present embodiment;

FIG. 7 is a perspective view showing magnets and a rotation unit according to an embodiment of the present disclosure; and

FIGS. 8 to 11 are cross-sectional views showing the arrangement of magnets according to various embodiments of the present disclosure.

### DETAILED DESCRIPTION OF THE EMBODIMENTS

Hereinafter, various embodiments of the present disclosure will be described in detail with reference to the accompanying drawings so that those skilled in the art can easily carry out them. The present disclosure may be modified in various different ways, and is not limited to the embodiments set forth herein.

Portions that are irrelevant to the description will be omitted to clearly describe the present disclosure, and like reference numerals designate like elements throughout the description.

Further, in the drawings, the size and thickness of each element are arbitrarily illustrated for convenience of description, and the present disclosure is not necessarily limited to those illustrated in the drawings. In the drawings, the thickness of layers, regions, etc. are exaggerated for clarity. In the drawings, for convenience of description, the thicknesses of a part and an area are exaggeratedly illustrated.

Further, it will be understood that when an element such as a layer, film, region, or plate is referred to as being “on” or “above” another element, it can be directly on the other element or intervening elements may also be present. In contrast, when an element is referred to as being “directly on” another element, it means that other intervening elements are not present. Further, a certain part being located “above” or “on” a reference portion means the certain part being located above or below the reference portion and does not particularly mean the certain part “above” or “on” toward an opposite direction of gravity.

Further, throughout the description, when a portion is referred to as “including” or “comprising” a certain component, it means that the portion can further include other components, without excluding the other components, unless otherwise stated.

Further, throughout the description, when it is referred to as “planar”, it means when a target portion is viewed from the upper side, and when it is referred to as “cross-sectional”, it means when a target portion is viewed from the side of a cross section cut vertically.

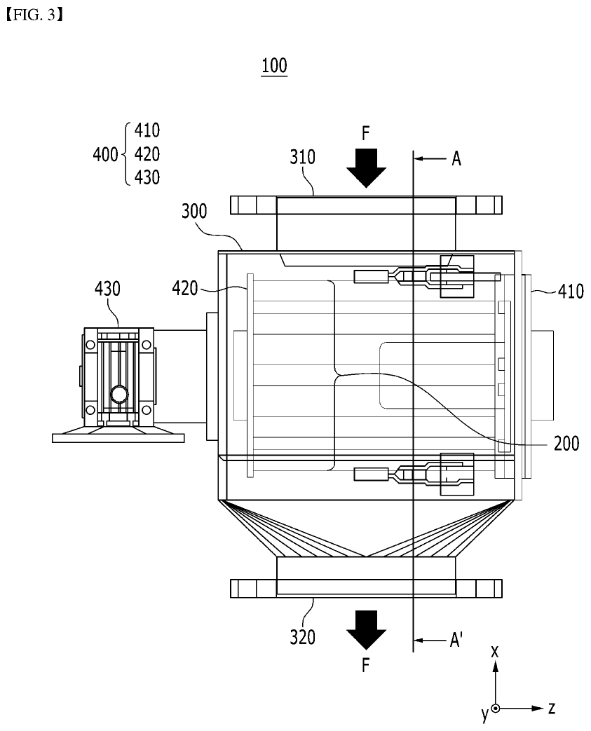

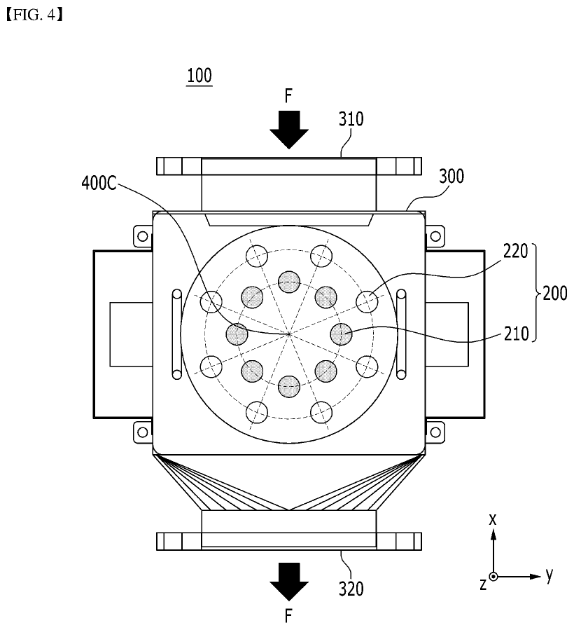

FIG. 3 is a side view showing a side surface of a magnetic filter according to an embodiment of the present disclosure. FIG. 4 is a cross-sectional view taken along the line A-A′ of FIG. 3.

Referring to FIGS. 3 and 4, the magnetic filter 100 according to an embodiment of the present disclosure includes a housing 300 through which fluid or powder containing metal particles passes; magnets 200 arranged inside the housing 300; and a rotation unit 400 that rotates the magnets 200 so as to revolve around a rotation center 400C.

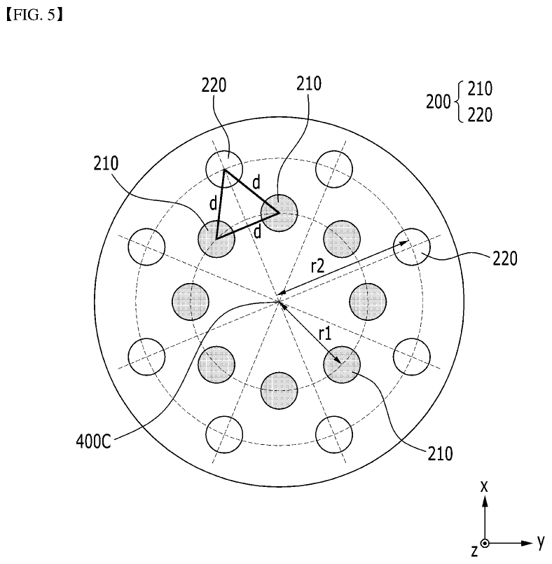

The arrangement shapes of the magnets 200 will be described later in detail with reference to FIG. 5.

The housing 300 may have a cylindrical shape of which the inside is hollow. Such a housing 300 may include an inlet port 310 through which fluid or powder flows in, and an outlet port 320 through which the fluid or powder flowed through an inlet port 310 is discharged. The fluid or powder containing metal particles may be flowed into a housing 300 through an inlet port 310 and then discharged to the outside through an outlet port 320 in the direction of the arrow “F” shown in FIG. 3. An opening direction of the inlet port 310 and an opening direction of the outlet port 320 may be parallel to each other. That is, the fluid or powder can pass through the inside of the housing 300 in a straight line along the direction of the arrow indicated by “F”, that is, the −x-axis direction.

The magnets 200 may have a columnar shape extending along one direction. Specifically, the magnets 200 may have a columnar shape extending along a direction parallel to the extension direction of the rotation axis with respect to a virtual rotation axis (a direction parallel to the z-axis) corresponding to the rotation center 400C. Its shape is not limited as long as it is in a form extending along one direction, and it may be a circular column or a polygonal column.

More specifically, the magnets 200 may have a columnar shape extending along a direction perpendicular to a direction from the inlet port 310 to the outlet port 320. That is, the columnar magnets 200 may be arranged in a form extending perpendicularly to a direction in which fluid or powder passes.

At this time, the metal particles contained in the fluid or powder that has flowed into the inside of the housing 300 can be removed by the magnets 200 arranged inside the housing 300. Here, the removal of the metal particles means that the metal particles are separated from the fluid or powder.

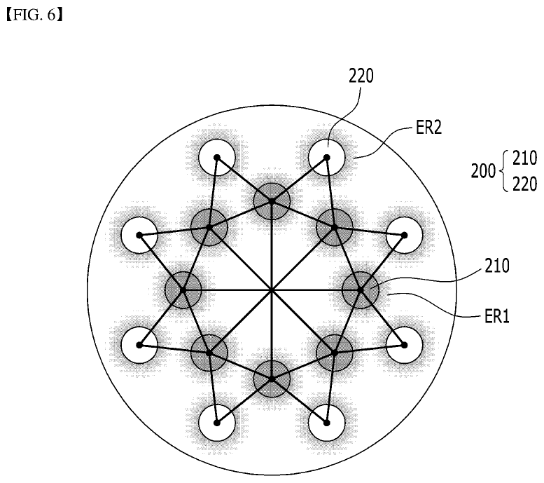

FIG. 5 is a cross-sectional view schematically showing only magnets in the magnetic filter of FIG. 4. FIG. 6 is a schematic diagram expressing the magnetic force effective range of the magnets according to the present embodiment.

Referring to FIGS. 3 to 6 together, the magnets 200 according to the present embodiment include first magnets 210 and second magnets 220 located further from the rotation center 400C than the first magnets 210. As an example, the first magnets 210 may be spaced apart from the rotation center 400C of the rotation unit 400 by a first radius r1, and the second magnets 220 may be spaced apart from the rotation center 400C of the rotation unit 400 by a second radius r2 greater than the first radius r1. Here, the rotation center 400C may mean a virtual rotation axis at which the first magnets 210 and the second magnets 220 rotate. The second magnets 220 may be arranged in the outskirts far away from the rotation center 400C than the first magnets 210.

At this time, one of the second magnets 220 forms an equilateral triangle arrangement with two first magnets 210 adjacent to any one of the second magnets 220. As shown in FIG. 5, any one of the second magnets 220 may form an equilateral triangle arrangement while having the same center distance d as the two adjacent first magnets 210.

The first magnets 210 may be arranged in a circular or polygonal shape with respect to the rotation center 400C. As an example, FIG. 6 shows a state in which eight first magnets 210 are arranged in a circular shape separated by the same first radius r1 with respect to the rotation center 400C.

Further, the rotation center of the first magnets 210 and the rotation center of the second magnets 220 may be the same. That is, the first magnets 210 and the second magnets 220 may be configured to rotate while having the same virtual rotation axis.

In order to form the equilateral triangle arrangement mentioned above, the number of first magnets 210 and the number of second magnets 220 may be the same. As an example, each of the first magnets 210 and the second magnets 220 may be composed of eight. Instead, the positions of the first magnets 210 and the positions of the second magnets 220 are arranged so as to be deviated from each other with respect to the radial direction, thereby capable of forming the above-mentioned equilateral triangular arrangement.

The first magnets 210 and the second magnets 220 according to the present embodiment are designed so as to calculate the effective range of foreign matter collection according to magnetic force and allow fluid or powder to pass through the effective range. Specifically, in FIG. 6, the effective range ER1 for the magnetic force of the first magnets 210 and the effective range ER2 for the magnetic force of the second magnets 220 are shown in a form of shadow. Referring to FIG. 6, in the first magnets 210 and the second magnets 220, any one of the second magnets 220 and two first magnets 210 adjacent thereto are designed so as to have a closest-packed structure while forming an equilateral triangle arrangement, so that the interior regions of the housing through which the fluid or powder passes are included within the effective range of the magnetic force of the rotating first magnets 210 and second magnets 220. As an example, the magnets 200 may all have a magnetic strength of 14,000 Gauss, and a center distance (d) between the second magnet 220 and two adjacent first magnets 210 may be 50 mm or more and 60 mm or less. At this time, the diameter of the magnets 200 may be 24 mm or more and 26 mm or less, whereby the surface distance between the second magnets 220 and the two adjacent first magnets 210 may be 24 mm or more and 36 mm or less. This structure makes it possible to realize a most dense structure so that the region through which fluid or powder passes is completely included in the magnetic force effective range of magnetic force of the rotating magnets 200.

The closet-packed structure according to the present embodiment corresponds to a form in which magnets arranged in two rows in a grate type magnetic filter are rolled up in a circle, and exhibits foreign matter collection performance equivalent to two grate type magnetic filters of the closest-packed structure having two rows of magnets. In other words, even when it is a rotary type magnetic filter 100, it can exhibit a foreign matter collection performance similar to that of a grate type magnetic filter. Therefore, it is possible to solve the material clogging phenomenon, which is a drawback of the grate type magnetic filter, and to have excellent foreign matter collection performance like a high-low type magnetic filter in a limited space.

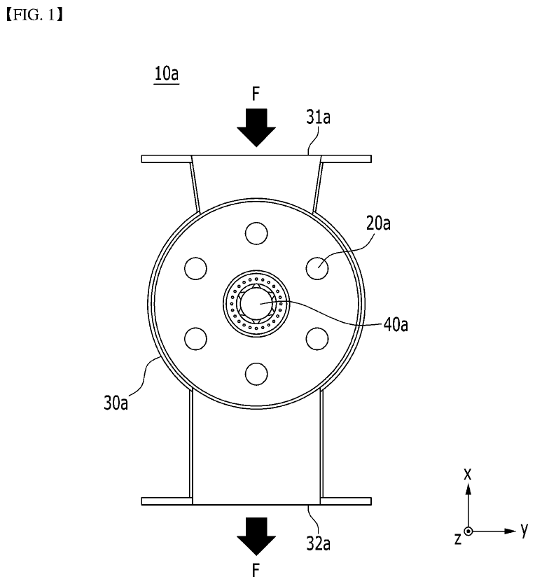

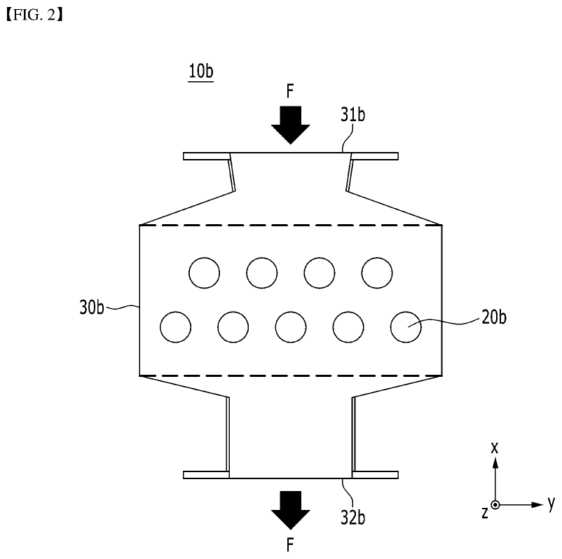

The magnetic filter 100 according to the present embodiment is configured in such a manner that the first magnets 210 and the second magnets 220 rotate, thereby effectively securing fluid flowability, and also the first magnets 210 and the second magnets 220 forming an equilateral triangle arrangement are arranged in the closet-packed structure, thereby greatly improving the foreign matter collection performance. That is, compared to the conventional rotary type magnetic filter and the grate type magnetic filter shown in FIGS. 1 and 2, it has the advantage of being able to ensure both fluid flowability and foreign material removal performance.

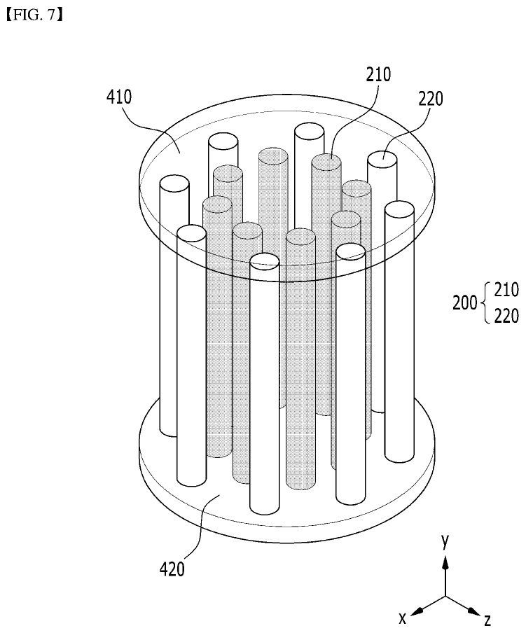

FIG. 7 is a perspective view showing magnets and a rotation unit according to an embodiment of the present disclosure.

Referring to FIGS. 3 and 7 together, the rotation unit 400 according to the present embodiment may include a first rotation plate 410 connected to one end of the first magnets 210 and one end of the second magnets 220; a second rotation plate 420 connected to the other end of the first magnets 210 and the other end of the second magnets 220; and a rotary motor 430 connected to any one of the first rotation plate 410 and the second rotation plate 420. The first rotation plate 410 and the second rotation plate 420 may be circular plates. The centers of the first rotation plate 410 and the second rotation plate 420 may correspond to the above-mentioned rotation centers of the first magnets 210 and the second magnets 220. As the rotary motor 430 rotates either one of the first rotation plate 410 and the second rotation plate 420, the first magnets 210 and the second magnets 220 can rotate. However, this is an exemplary structure of the rotation unit 400, and various embodiments can be made as long as the first magnets 210 and the second magnets 220 can be rotated.

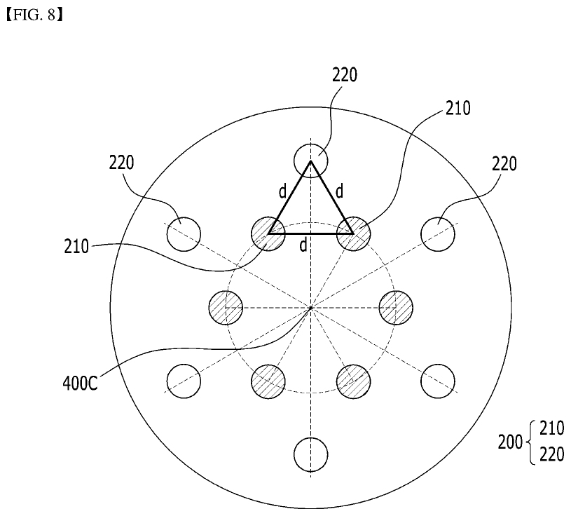

FIGS. 8 to 11 are cross-sectional views showing the arrangement of magnets according to various embodiments of the present disclosure. Specifically, FIGS. 8 to 11 are cross-sectional views which schematically show the arrangement of magnets according to the present embodiment, similarly to those shown in FIG. 5.

First, referring to FIG. 8, the magnets 200 according to the present embodiment include first magnets 210 and second magnets 220 as described above. The first magnets 210 can be arranged in a circular shape with a constant separation distance from the rotation center 400C. The second magnets 220 can be disposed outside the first magnets 210 so as to form an equilateral triangle arrangement with the two first magnets 210 adjacent thereto. Each of the six first magnets 210 and the second magnets 220 can be arranged.

The magnetic filter including the magnets 200 shown in FIG. 8 may have a kind of schematic structure. That is, it corresponds to an embodiment of the magnets 200 that can be applied when the installation space of the magnet filter is limited.

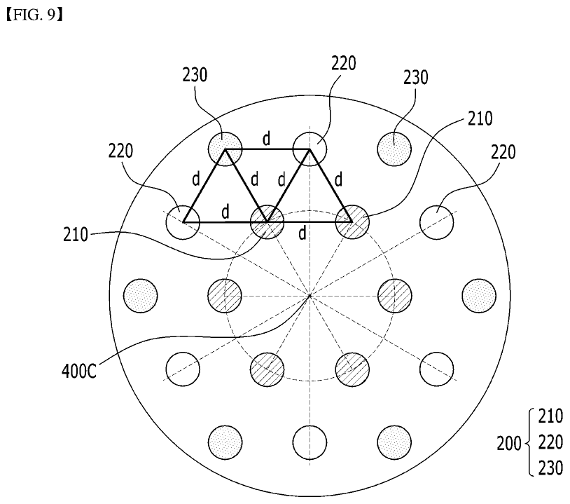

Referring to FIG. 9, the magnets 200 according to another embodiment of the present disclosure may further include third magnets 230 arranged between the second magnets 220. The third magnet 230 may be arranged to be separated by the same distance d as each of the adjacent second magnets 220.

At this time, one of the third magnets 230 may form an equilateral triangle arrangement with one of the second magnets 220 adjacent to one of the third magnets 230 and the first magnets 210 adjacent to one of the third magnets 230. As shown, the third magnet 230 is adjacent to the two second magnets 220 and is spaced apart by the same distance d as each of the adjacent second magnets 220, and at the same time, may be spaced apart by the same distance d as the first magnets 210. Therefore, the first magnets 210, the second magnets 220, and the third magnets 230 may form an equilateral triangle arrangement.

In the present embodiment, the first magnets 210 and the second magnets 220 are arranged similarly to those shown in FIG. 8, and additionally, the same number of third magnets 230 as the number of first magnets 210 or second magnets 220 can be arranged in the above-mentioned manner.

The magnets 200 shown in FIG. 9 can be arranged in a layout corresponding to the <111> plane of a face-centered cubic (FCC) structure to form the closest-packed structure. The embodiment of FIG. 9 corresponds to an application embodiment capable of widening the collection range of magnets compared to the embodiment of FIG. 8.

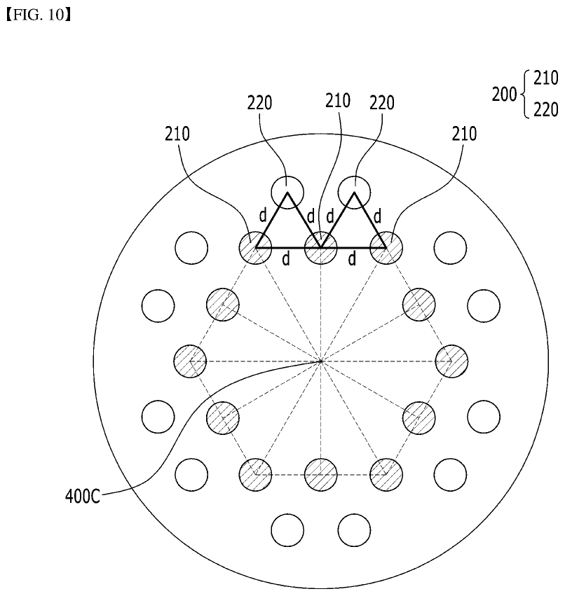

Next, referring to FIG. 10, the magnets 200 according to the present embodiment include first magnets 210 and second magnets 220. However, unlike the embodiments described above, the first magnets 210 may be arranged in a polygonal shape with respect to the rotation center 400C. As an example, in FIG. 10, 12 first magnets 210 may be arranged in a hexagonal shape.

The second magnets 220 may be arranged outside the first magnets 210 so as to form an equilateral triangle arrangement with the two first magnets 210 adjacent thereto. As an example, two second magnets 220 separated by a certain distance d from each of the two first magnets 210 among the three first magnets 210 forming one side of the hexagonal arrangement can be arranged. Finally, FIG. 10 shows a state in which a total of 12 second magnets 220 are arranged so as to correspond to 12 first magnets 210.

The magnets 200 shown in FIG. 10 can be arranged in a layout corresponding to the <111> plane of a face-centered cubic (FCC) structure to form the closest-packed structure. The embodiment of FIG. 10 corresponds to an embodiment that can be applied when the installation space of the magnetic filter is larger than that of the embodiment of FIG. 8.

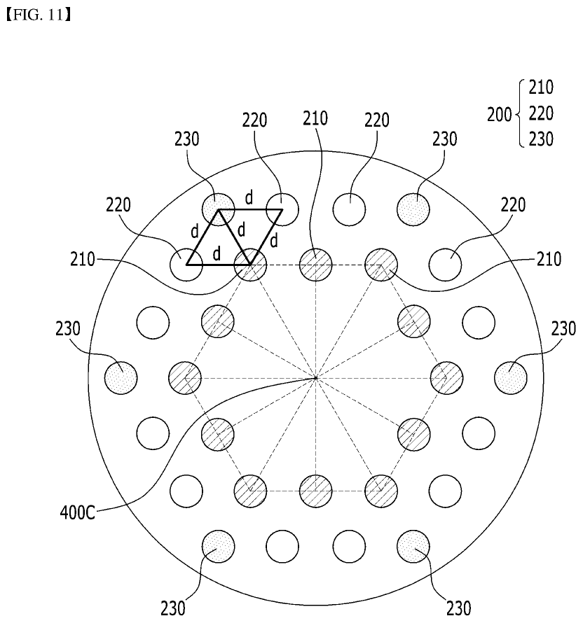

Next, referring to FIG. 11, the magnets 200 according to another embodiment of the present disclosure may further include third magnets 230 arranged between the second magnets 220. The third magnets 230 may be arranged so as to be separated by the same distance (d) as each of the adjacent second magnets 220.

At this time, one of the third magnets 230 may form an equilateral triangular arrangement with one of the second magnets 220 adjacent to one of the third magnets 230, and a first magnet 210 adjacent to one of the third magnets 230. As shown, the third magnets 230 are adjacent to the two second magnets 220 and are separated by the same distance “d” as each of the adjacent second magnets 220, and at the same time, may be separated by the same distance “d” even from the first magnet 210. Therefore, the first magnets 210, the second magnets 220, and the third magnets 230 may form an equilateral triangle arrangement.

In the present embodiment, the first magnets 210 and the second magnets 220 are arranged similarly to those shown in FIG. 10, and additionally, six third magnets 230 may be arranged in the manner mentioned above.

The magnets 200 shown in FIG. 11 can be arranged in a layout corresponding to the <111> plane of a face-centered cubic (FCC) structure to form the closest-packed structure. FIG. 11 corresponds to an embodiment that can be applied when the installation space of the magnetic filter is larger.

The terms representing directions such as the front side, the rear side, the left side, the right side, the upper side, and the lower side have been used in the present embodiment, but the terms used are provided simply for convenience of description and may become different according to the position of an object, the position of an observer, or the like.

Although preferred embodiments of the present disclosure have been described in detail above, the scope of the present disclosure is not limited thereto, and various modifications and improvements can be made by those skilled in the art using the basic concepts of the present disclosure, which are defined in the appended claims, which also falls within the scope of the present disclosure.

### DESCRIPTION OF REFERENCE NUMERALS

100: magnetic filter
200: magnets
210: first magnets
220: second magnets
300: housing
310: inlet port
320: outlet port
400: rotation unit

1. A magnetic filter comprising:
a housing configured to receive passing therethrough a fluid or a powder containing metal particles;
magnets arranged inside the housing; and
a rotation unit configured to rotate the magnets to revolve around a rotation center thereof,
wherein the magnets include first magnets and second magnets, each of the second magnets located farther from the rotation center than the first magnets, and
wherein any one of the second magnets forms an equilateral triangle arrangement with two of the first magnets that are closest to the any one of the second magnets.

2. The magnetic filter according to claim 1, wherein the first magnets are together arranged along a circular shape with respect to the rotation center.

3. The magnetic filter according to claim 1, wherein the first magnets are together arranged along a polygonal shape with respect to the rotation center.

4. The magnetic filter according to claim 1, wherein the magnets each have a columnar shape extending in a first direction.

5. The magnetic filter according to claim 1, wherein the housing includes an inlet port configured to receive an inflow therethrough of the fluid or the powder and an outlet port configured to receive a discharge therethrough of the fluid or the powder from the inlet port, and an opening direction of the inlet port and an opening direction of the outlet port are parallel to each other.

6. The magnetic filter according to claim 5, wherein the magnets each have a columnar shape extending in a first direction perpendicular to a second direction extending from the inlet port towards the outlet port.

7. The magnetic filter according to claim 1, wherein the magnets further comprise third magnets each arranged equidistant from two of the second magnets that are closest thereto.

8. The magnetic filter according to claim 7, wherein each of the third magnets is separated from a closest one of the first magnets by a same distance as each of the second magnets that are closest thereto.

9. The magnetic filter according to claim 7, wherein one of the third magnets forms an equilateral triangle arrangement with one of the second magnets and one of the first magnets.

10. The magnetic filter according to claim 1, wherein the rotation unit comprises a first rotation plate connected to a first end of each of the first magnets and a first end of each of the second magnets, a second rotation plate connected to a second end of each of the first magnets and a second end of each of the second magnets, and a rotary motor connected to one of the first rotation plate or the second rotation plate.
